(19) United States
(12) Patent Application Publication
(10) Pub. No.: US 2005/0135286 A1
(43) Pub. Date: Jun. 23, 2005

(54) Wireless extended proximity networks: systems, methods and program products

(76) Inventors: Jukka K. Nurminen, Espoo (FI); Szabolcs Fodor, Budapest (HU); Balazs Bakos, Torokbalint (HU)

Correspondence Address: MORGAN & FINNEGAN, L.L.P., 3 WORLD FINANCIAL CENTER, NEW YORK, NY, 10281-2101, US

(21) Appl. No.: 10/742,799

(22) Filed: Dec. 23, 2003

(51) Int. Cl. H04B 7/00

(52) U.S. Cl. 370/310

(57) ABSTRACT

A wireless proximity network is extended to provide peer-to peer communication among ad hoc networks. A mobile device (peer) coupled to an access point serves an adhoc network via a short-range communication link. The peer executes a Bluetooth protocol stack. Each peer has a routing table about all the peers in the adhoc network. A peer to peer software layer (P2P) runs on top of the Bluetooth protocol stack and beneath a multi-user application layer. The P2P software handles application deployment, peer management and communications for applications and provides information about existing peers on the adhoc network; routes messages between peers within an ad hoc network and from one peer to another in different adhoc networks. The access point is connected to a wireless LAN via a wireless router. The access point has an IP-BT address conversion table and communicates with other access points via wireless routers using TCP/IP protocols.

### BACKGROUND OF INVENTION

1. Field of Invention

This invention relates to communication systems, methods and program products. More particularly, the invention relates to wireless extended proximity networks: systems, methods and program products.

2. Description of Prior Art

Currently proximity networks (Piconets), e.g. Bluetooth communicate with other devices in the network. A problem with Bluetooth proximity networks is that they are limited to a very small number of users, typically less than eight (8), and to a very small geographic area, typically less than 10 meters. However, “scatternet” is a Bluetooth system, which supports both point-to-point and point-to-multi-point connections. Several Piconets can be established and linked together in a “scatternet,” where each piconet is identified by a different frequency hopping sequence. All devices participating in the same piconet are synchronized to their respective hopping sequence. Although active research is going on in scatternets, there are still many technical problems to be solved and the current mobile terminal does not support scatternets.

To make proximity networks more usable, it would be desirable to wirelessly extend proximity network to other proximity networks served by other access points. The extended proximity network would permit peer-to-peer communication between mobile phones (peers) in different proximity networks via access points without the limitations of the prior art.

Prior art related to extended proximity networks includes:

A. U.S. Pat. No. 6,535,498B1 issued Mar. 18, 2003 discloses controlling a remote device over a wireless connection. In one embodiment, a hand-held computer system having a Bluetooth-enabled transceiver is used to control other Bluetooth-enabled devices. A wireless connection between a transceiver and a remote device is established. A position where a stylus makes contact with a surface of an input device of the hand-held computer system is registered. The particular position where the stylus element makes contact with the input device is translated into a particular command for controlling the remote device. The command is then transmitted to the remote device over the wireless connection.

B. U.S. Pat. No. 6,452,910 B1 issued Sep. 17, 2002 discloses A Wireless bridge conjoins two previously incompatible technologies within a single device to leverage the strengths of each. The Wireless bridge marries the Personal Area Network (PAN) technology of Bluetooth as described in Bluetooth Specification Version 1.0B with the Wireless Local Area Network (WLAN) technology described in the IEEE802.11a specification to provide a wireless system level solution for peripheral devices to provide Internet service interactions. The invention brings together in a single working device implementations of these technologies so they do not interfere or disrupt the operation of each other and instead provide a seamless transition of a Bluetooth connection to Wireless Local Area Network/Internet connection. From the Wireless Local Area Network perspective the inventive wireless bridge extension allows a Bluetooth-enabled device to roam from one Wireless Access Point (bridge) to the next without losing its back end connection. The invention takes into account the minimum separation and shielding required of these potentially conflicting technologies to inter-operate.

None of the prior art discloses mobile devices connected to access points linked together in a mesh infrastructure via wireless routers, the access points and the mobile devices including middleware software handling application deployment, peer management and communication between peers for multi-user applications, enabling the mobile device (peer) to communicate with any peer in the same mesh infrastructure.

### SUMMARY OF INVENTION

A system, method and software enable peer-to peer communication among ad hoc networks. A mobile device is coupled to an access point serving an adhoc network via a short-range communication link. The mobile device executes a Bluetooth protocol stack and uses a mobile information device profile and JSR82 standard APIs. A peer-to-peer software layer (P2P) runs on top of the Bluetooth protocol stack and beneath a multi-user application layer. The P2P software handles the application deployment, peer management and communications between peers for multi-user applications and provides information about existing peers on the adhoc network; routes messages between peers within an ad hoc network and from one peer to another in different adhoc networks. The access point interacts with the mobile device using Bluetooth protocols and executes the P2P software. The access point is connected to a wireless LAN via a wireless router. The LAN serves other access points via wireless routers. Each access point communicates with other access points using TCP/IP or UDP/IP or other network protocols. The P2P software combines several Bluetooth and wireless IP links into one end-to-end communication path, which will carry the traffic, generated by the user applications. The application software does not need to know if the number of peers is limited to a single adhoc network or if the network has hundreds or even thousands of peers.

In operation, the access point receives a message from a mobile or peer device. Each peer has one address that is unique to the connected network. The peers have information only about the connections to the neighboring peers in the adhoc network. The peers have no information about any remote connections. Each peer has a routing table about all the peers in the adhoc network. For every peer in the network the routing table has one item that contains the peer address in the adhoc network and the associated outgoing connection used in message routing.

In an alternative embodiment of the innovation the access point has an IP-BT address conversion table and the terminals would have no routing table at all. The access point analyzes the received message and determines the next level of address for forwarding the message without changing the recipient address in the message. The next level of address forwards the message without changing the recipient address enabling the at least two mobile devices (peers) in different adhoc networks to communicate with each other.

An aspect of the invention is an extended proximity network enabling peer to peer communication between mobile devices (peers) in different networks.

Another aspect is a plurality of access point connected in an adhoc mesh via wireless routers and enabling peer-to-peer communication between mobile devices in different proximity networks.

Another aspect is a software layer installed beneath a multi-user application layer in a communication protocol stack and responsible for peer-to-peer communication between access points and mobile devices (peers) in a mesh network.

Another aspect is a software layer installed in a communication protocol stack of each mobile device and access point in a proximity network, the software layer routing all messages, managing connections and maintaining a list about available peers.

Another aspect is a software layer installed in each mobile device and access point in a proximity network, the software layer handling multiple connection types and providing information about existing peers in a mesh infrastructure.

Another aspect is an extended proximity network including a routing table for each peer enabling connections within the network and connections to a peer in a different network.

Another aspect is mesh infrastructure of access points communicating with mobile devices via short range wireless communication protocols or with other access points by standard network transmission protocols.

Another aspect is an access point including a conversion table for converting a device address to an IP address for peer to peer communication in different proximity networks.

Another aspect is an access point detecting the departure of a user executing a proximity application in an adhoc network; buffering the application data during the absence of the user and downloading the buffered data to the user upon re-connection to the ahoc network.

### DESCRIPTION OF DRAWINGS

The invention will be further understood from the following detailed drawings, taken in conjunction with an appended drawing, in which:

FIG. 1 is a representation of a mesh infrastructure for wirelessly extending proximity networks including mobile devices, access points and wireless routers linked together via a wired or wireless Local Area Network (LAN) or a wireless mesh and incorporating the principles of the present invention;

FIG. 2 is a representation of a Bluetooth protocol stack incorporated into the mobile devices of FIG. 1, and modified to include middleware responsible for peer-to-peer communication between access points and mobile devices;

FIG. 3 is a representation of the middleware software component installed in the mobile devices and the access points of FIG. 1 enabling a peer to peer network (P2P);

FIG. 4 is an addressing and routing diagram including a routing table in each peer device and each access point in FIG. 1 for peer to peer communication;

FIG. 4A is a ladder diagram of a Peer in FIG. 4 joining a network;

FIG. 4B is a ladder diagram of a Peer sending a message to another Peer in the mesh infrastructure of FIG. 1

FIG. 4C is message flow diagram of the middleware at a Peer receiving a message sent from another Peer in the mesh infrastructure of FIG. 1;

FIG. 5 is an addressing and routing diagram including a conversion table installed in each access point in FIG. 1 for communicating peer messages between access points;

FIG. 5A is message flow diagram of the middleware providing an Access point a control message in the mesh infrastructure of FIG. 1;

FIG. 5B is a message flow diagram of the middleware forwarding a data message to a Peer in the mesh infrastructure of FIG. 1;

FIG. 6 is a flow diagram of middleware in a mobile device/access point for forming a network, sending or receiving messages and leaving a network in the mesh infrastructure of FIG. 1.

FIG. 7 is a representation of an application layer and a Middleware layer including Midlet Applications in a Bluetooth protocol stack in a Peer device for implementing various proximity usages in the mesh infrastructure of FIG. 1;

FIGS. 8A-8C are representations of screen displays in a mobile device implementing a proximity application for ordering merchandise in the mesh infrastructure of FIG. 1;

FIGS. 9A-9C are representations of screen displays in a mobile device implementing a proximity application for sending a message with a picture to another Peer in the mesh infrastructure of FIG. 1;

FIGS. 10A-10C are representations of screen displays in a mobile device implementing a proximity application for locating buddies at a public event in the mesh infrastructure of FIG. 1;

FIG. 11 is a flow diagram of improved messaging at an Access Point for a proximity application while a user is temporarily disconnected from the Access Point in the mesh infrastructure of FIG. 1, and

### DESCRIPTION OF PREFERRED EMBODIMENT

Proximity networks are based on short-range wireless systems and a brief description of the technology should aid in a better understanding of the invention, as follows:

A. Short-Range Wireless Systems

Short-range wireless systems have a typical range of one hundred meters or less. They often combine with systems wired to the Internet to provide communication over long distances. The category of short-range wireless systems includes wireless personal area networks (PANs) and wireless local area networks (LANs). They have the common feature of operating in unlicensed portions of the radio spectrum, usually either in the 2.4 GHz Industrial, Scientific, and Medical (ISM) band or the 5 GHz Unlicensed-National Information Infrastructure (U-NII) band. Wireless personal area networks use low cost, low power wireless devices that have a typical range of ten meters. The best-known example of wireless personal area network technology is the Bluetooth Standard, which operates in the 2.4 GHz ISM band. It provides a peak air link speed of one Mbps and a power consumption low enough for use in personal, portable electronics such as PDAs and mobile phones. Wireless local area networks generally operate at higher peak speeds of between 10 to 100 Mbps and have a longer range, which requires greater power consumption. Wireless local area networks are typically used as wireless links from portable laptop computers to a wired LAN, via an access point (AP). Examples of wireless local area network technology include the IEEE 802.11 Wireless LAN Standard and the HiperLAN Standard, which operates in the 5 GHz U-NII band.

B. Bluetooth Short-Range Wireless Technology

Bluetooth is a short-range radio network, originally intended as a cable replacement. It can be used to create networks of up to eight devices operating together. The Bluetooth Special Interest Group, Specification Of The Bluetooth System, Volumes 1 and 2, Core and Profiles: Version 1.1, 22nd Feb., 2001, describes the principles of Bluetooth device operation and communication protocols. The devices operate in the 2.4 GHz radio band reserved for general use by Industrial, Scientific, and Medical (ISM) applications. Bluetooth devices are designed to find other Bluetooth devices within their ten meter radio communications range and to discover what services they offer, using a service discovery protocol (SDP).

The SDP searching function relies on links being established between the requesting Bluetooth device, such as a stationary access point device, and the responding Bluetooth device, such as a mobile user's device. When the mobile user's device enters within communicating range of the access point, its Link Controller layer in its transport protocol group handles the exchange of inquiry and paging packets to establish the initial link with the access point device. This process is relatively fast, typically being completed in approximately from one to five seconds. Then, the Logical Link Control and Adaptation Protocol (L2CAP) layer in the transport protocol group passes the link status up to the RFCOMM/SDP layer. RFCOMM provides serial port emulation, which can be used to connect to legacy application and data transfer using several Bluetooth profiles. The Service Discover Protocol (SDP) searching function can then be used to find out about application programs in the responding Bluetooth device that may provide desired services. The SDP searching function can require several seconds to complete, depending on the complexity of the search and the size of the device's registry.

An example application program service that can be discovered by the SDP searching function is the Wireless Application Environment (WAE) graphical user interface (GUI) function of the Wireless Application Protocol (WAP). WAP-enabled wireless devices can use a microbrowser to display content on a small screen of the device. WAP uses a combination of Internet protocols with other protocols especially modified to work with mobile terminals. The Internet protocols are: Point to Point Protocol (PPP), Internet Protocol (IP), and User Datagram Protocol (UDP). The special mobile terminal protocols are: Wireless Transport Layer Security (WTLS), Wireless Transaction Protocol (WTP), Wireless Session Protocol (WSP), and Wireless Application Environment (WAE). It is the WAE that provides the microbrowser user interface for WAP. In order to establish a connection to send content from the requesting access point device to the WAE microbrowser of the responding user's device, each of the WAP protocol layers WTLS, WTP, WSP, and WAE must be established, which can require several more seconds to complete and possibly significant user interaction on the way.

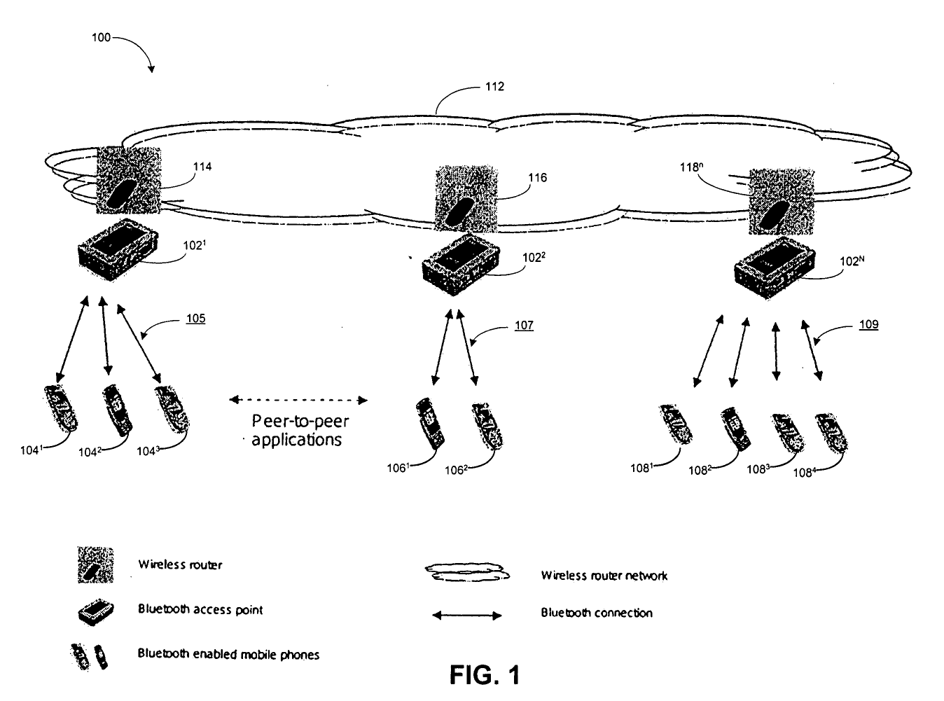

Now turning to FIG. 1, a mesh infrastructure 100 (Blue Mesh) includes a plurality of Access Points 102¹, 102² and 102^{N}. Each Access Point is coupled to at least one Bluetooth enabled mobile device. Access Point 102¹ is coupled to mobile devices 104¹, 104² and 104³ in a proximity network 105. Access Point 102² is linked to mobile devices 106¹ and 106² in a proximity network 107. Access Point 102^{N} is coupled to mobile devices 108¹, 108², 108³ and 108⁴ in a proximity network 109. The Access Points 102¹, 102² and 102^{N} are further coupled to a wireless LAN 112, via a wireless routers 114, 116 and 118, respectively.

Each mobile phone or terminal device (laptop, etc.) supports Bluetooth protocol, Java Mobile Information Device Profile (MIDP) and Java API for Bluetooth Wireless Technology (JSR82). The MIDP profile provides core application functionality for mobile applications, including the user interface, network connectivity, local data storage, and application management. MIDP when combined with Java 2, Micro Edition (J2ME) Connected Limited Device Configuration (CLDC) provides a run-time environment for a mobile device.

JSR82 provides Bluetooth capabilities to Java 2 MicroEdition including register services, device and services discovery, RFCOMM, L2CAP, and OBEX connections between devices to send and receive data. Details of MIDP, JSR82, J2ME and CLDC are available from Sun Microsystems, Inc, Mountainside, Calif. It should be noted that the principles of the invention can be implemented in other programming languages, e.g., Symbian C⁺⁺.

The Access Points are connected together in a mesh infrastructure 100 (identified as SuperSite) via LAN 112, and wireless routers 114, 116, 118^{N}. The Access Points also include a LAN Access Profile enabling a Bluetooth enabled device to access the mesh network. Further information relating to the mobile device connecting to the wireless LAN via a LAN Access Point is described in the textbook, “Bluetooth-Connect Without Cables”, by J. Bray et al., published by Prentice Hall, Upper Saddle River, N.J., Second Edition, pages 375-378, and fully incorporated herein by reference.

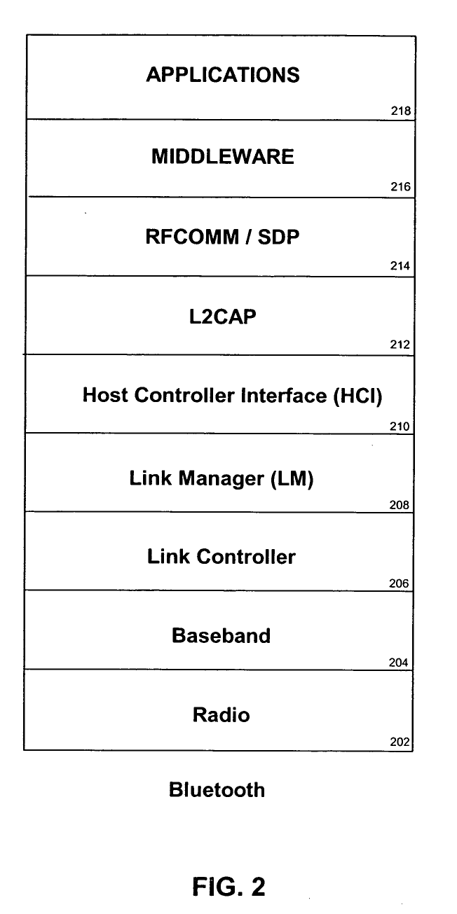

FIG. 2 discloses a Bluetooth Protocol stack 200 installed in the mobile devices and Access Points. The protocol stack includes a radio layer 202, which regulates and demodulates data for transmission and reception over air. Base band layer 204 and link controller 206 control the physical links via the radio, assembling packets and controlling frequency hopping. A host controller interface 210 handles communications between a separate host and a Bluetooth module. A logical link in control adaptation protocol (L2CAP) 212 provides segmentation and reassembly services to allow large packets to pass across Bluetooth links and multiplexes for higher layer protocols and services. An RFCOMM/SDP layer 214 provides a RS232 serial like interface and allows Bluetooth devices to discover services other Bluetooth devices support using the SDP protocol. A middleware layer 216 is disposed between the layer 214 and an application layer 218. Middleware could also be on top of the L2CAP layer or on top of OBEX. The middleware layer 216 hides the communication details from the applications and enables Peer-to-Peer (P2P) communication. The middleware or P2P software handles the application deployment, peer management and communications between peers for multi-user applications and provides information about existing peers on the adhoc mesh network; routes messages between peers within an ad hoc network and from one peer to another in different adhoc networks. Peer applications in the mobile devices are able to communicate with any peer in the same mesh infrastructure provided by the LAN 112. For peer to peer communication, the middleware combines several Bluetooth and wireless IP links into one logical end-to-end communication path, which will carry the traffic generated by user applications. The application software 218 does not need to know if the number of pairs is limited to a single proximity or piconet or if the proximity is hundreds or even thousands of peers.

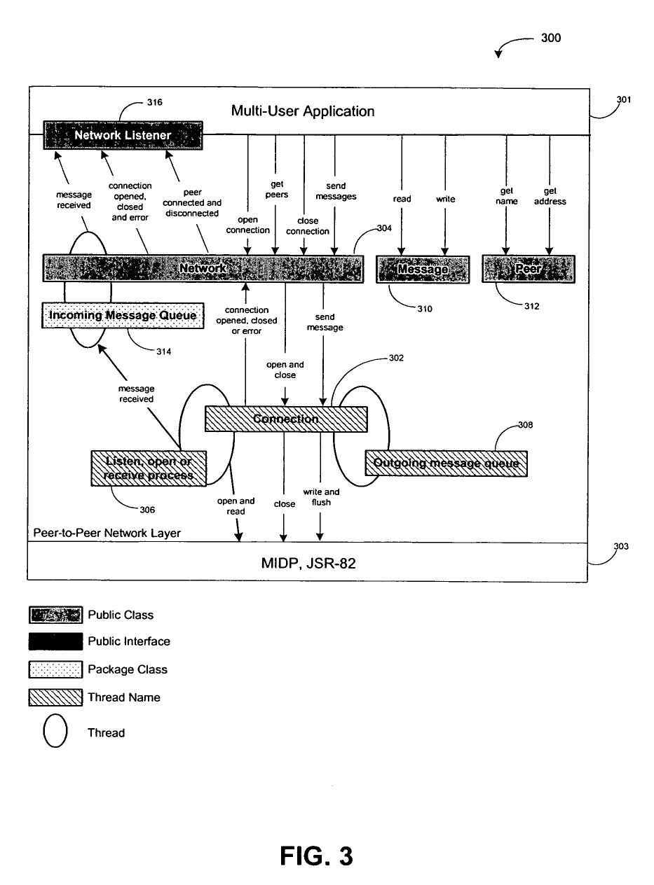

FIG. 3 describes the middleware or P2P network layer architecture 300 installed beneath a multi-user application layer 301 and interacting with MIDPs and JSR-82 interfaces 303. The key features of the P2P layer for peer to peer communication compared to normal MIDP or JSR 82 solutions are indicated below in Table 1.

TABLE 1

| Peer-to-Peer Network Layer | MIDP/JSR-82 |
|---|---|
| Message base communication, | Stream (e.g. IP socket) or packet |
| hiding the underlying protocol, | (e.g. L2CAP) based communication, |
| hiding the network topology, | keeping track of connections |
| addressing, | no addressing, |
| sending message regardless of hop | sending data only to the |
| count, | neighborhood, |
| multicast messages, | no multicast |
| message sending/receiving does | data sending/receiving may block |
| not block the current process, | the current process, |
| peer connected/disconnected | no peer events, |
| events, peer groups | no peer groups |

The P2P network layer architecture is implemented in object oriented programming (OOP). In one embodiment, the classes and interfaces are JAVA™ based. The heart of the network layer 300 is a connection class 302, a network class 304, a message class 310 a message queue class 314, and a stream connection class, all described below in Table 2.

TABLE 2
JAVA MIDP CLASSES & INTERFACES

```
Connection class:
  java.util.Hashtable
Message Class:
  java.io.ByteArrayInputStream
  java.io.ByteArrayOutputStream
  java.io.DataInputStream
  java.io.DataOutputStream
  java.io.IOException
MessageQueue class:
  java.util.Vector
Network class:
  java.util.Enumeration
  java.util.Hashtable
  java.util.Vector
Network class:
  java.util.Enumeration
SCC class:
  java.io.DataInputStream
  java.io.DataOutputStream
  java.io.IOException
  javax.microedtion.io.Connector
  javax.microedition.io.StreamConnection
  javax.microeditionStreamConnectionNotifiier
Note:
The *.io.* classes and interfaces are used for input/output operations. The java.util.* are used for storing objects.
```

The connection class 302 interacts with the network class in opening and closing connections; receiving opening and closing instructions, and messages from the network class. Each connection has two threads, one to handle connection events in a class 306 and another to store messages in an outgoing queue message class 308. The connection event class 306 opens and reads MIDP applications. The message queue class 308 writes and flushes MIDP application The MIDPs define APIs for user interface components, input and event handling, persistent storage, networking and timers, taking into consideration the screen and memory limitations from the mobile device. The APIs can be prepared using the JAVA™ MIDP Application's Developer's Guide For NOKIA Devices, V2, published Nov. 27, 2002, available from NOKIA Corporation, Helsinki, Finland, and fully incorporated herein by reference.

The network class includes an input message queue class 314 for receiving messages from the connection event class 306 as input to the network class and to a network listener 316 which interfaces the applications. The network listener is informed of the different connection events and peer connections by the network class. The network layer supports a StreamConnection class (SCC) and a L2CAP Connection class (both not shown) providing the network with socket, btspp and btl2cap connections.

The multi-user applications provide connection and peer instruction instructions and sends message to the network class. A message class 310 reads and writes messages from the multi-user application layer. A peer class 312 gets the names and addresses of peers from multi-user applications.

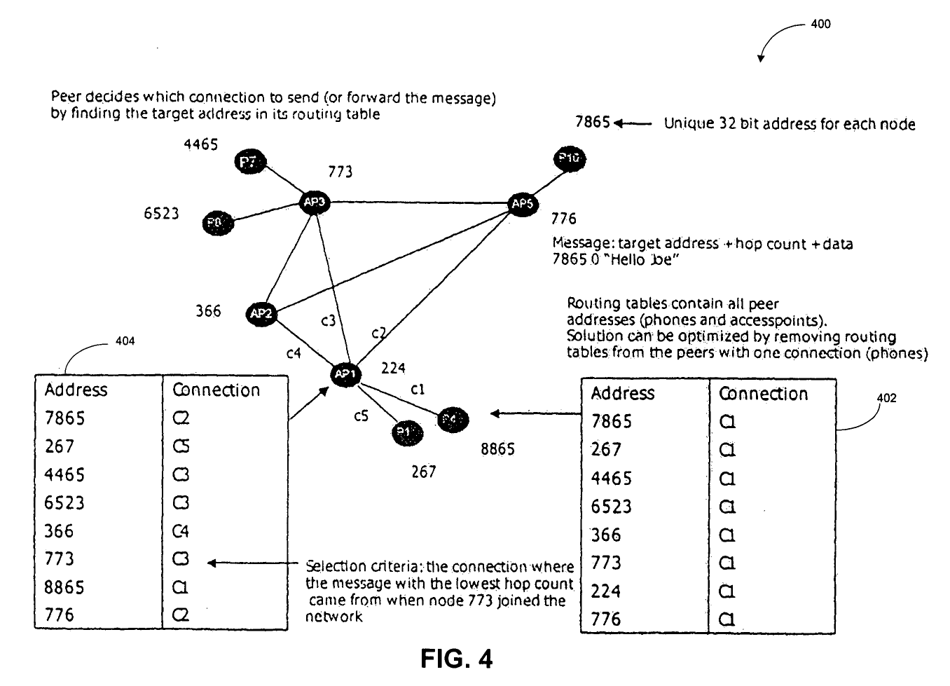

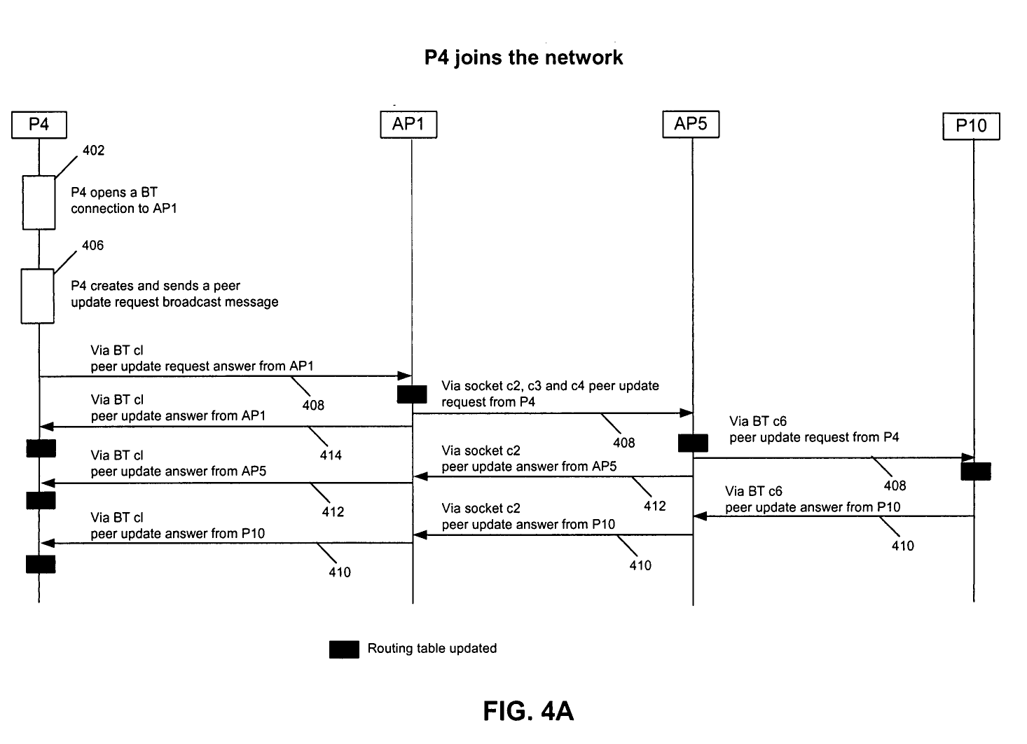

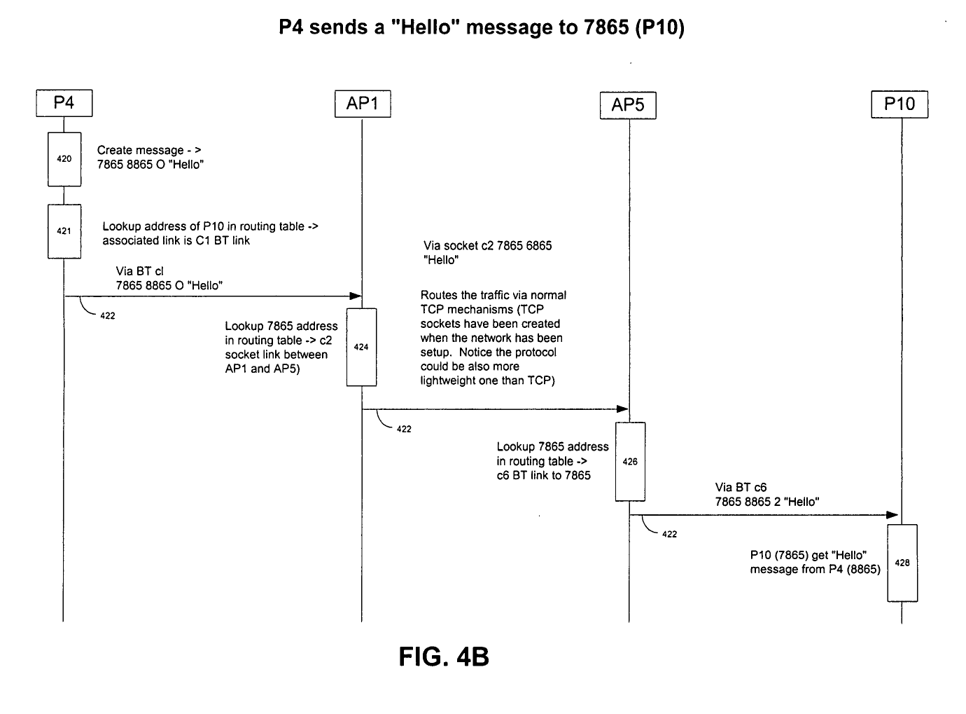

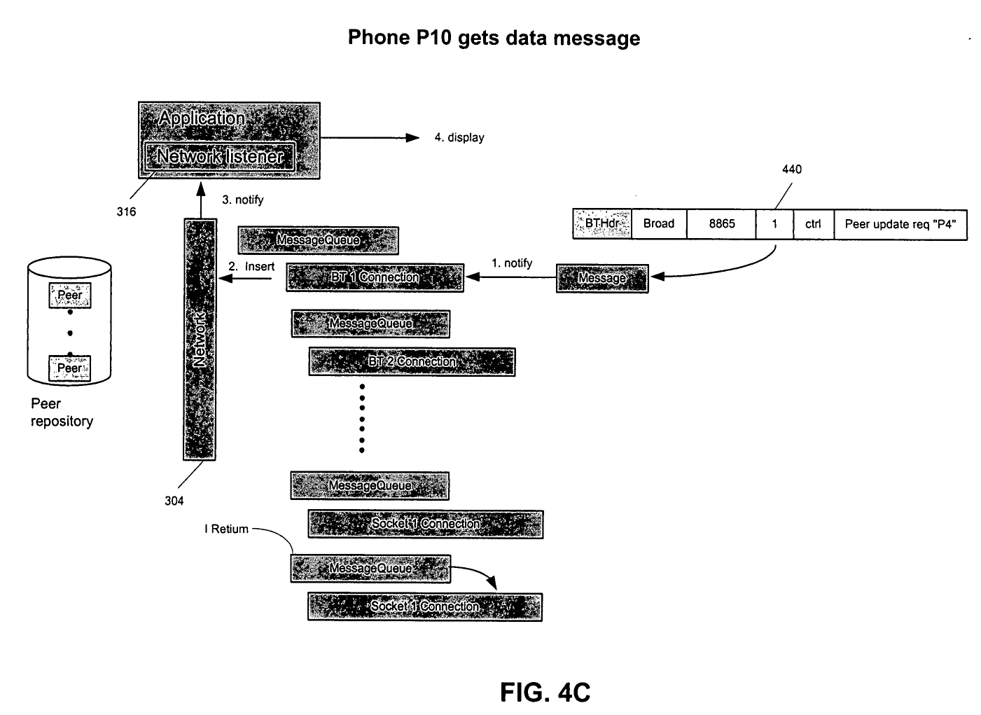

FIG. 4 discloses an addressing and routing diagram 400 for peer to peer connection using the P2P layer 300 shown in FIG. 3. Each peer (darkened circles in FIG. 4) is identified with a 32 bit address in an associated proximity network. Every peer has to have one address that is unique in the connected network. In one embodiment, the address is generated in the peer itself using a random number generator or its unique (Bluetooth) MAC address. Peers have information only about the connections to neighboring peers and have no knowledge about remote connections.

Every peer has a routing table identifying all the peers in the network. In the routing table, every peer in the network has one item that contains a peer address and a connection to a neighboring peer. When peer A has a message to send or forward to another peer, then the sending peer looks for the receiving peer address in its address table and sends the message on the associated connection. In the case of peer P4, a routing table 402 contains the addresses and connections for Peer 10, Peer 1, Peer 7, Peer 8, Access Point 2, Access Point 3, Access Point 1 and Access Point 5. The Access Point 1 contains a routing table 404 using the addresses and connection to neighboring peers. In this case, Access Point 1 contains the address of Access Point 2, Access Point 3 and Access Point 5, along with the addresses to the peers P1 and P4.

The routing tables are updated when new connections are created or connections are closed. The peer connected and disconnected events are propagated through the whole network. When new peer connections are added to the network, the peer sends a broadcast message (so called peer update message) to every peer. This message updates all of the routing tables. All of the peers will have a new item in their routing table, which consists of the address of the new peer and the address of the originating connection. The connection can be changed when the message comes with a better hop count from a new peer. When a connection is closed, between two peers, the peers invalidate the routing table items where the connection appears and send a so-called peer update request message to those peers where the connection has been in validated. The peers that are still connected with a different route will replay the peer update message. Other peers, who do not have a different route to the network and cannot answer within a certain time period, will be removed from the routing table. There is a specific message (so-called peer delete) to propagate the removal information in the network.

FIG. 4A is a ladder diagram depicting the Peer P4 joining the network 112 (see FIG. 1). In an operation 402, P4 opens a Bluetooth connection to Access Point 1 (AP1). P4 creates and sends a peer update request broadcast message 408 in an operation 406. The broadcast message 404 is sent via Bluetooth socket C1 to Access Point 1 which updates the routing table and forwards the Peer update request 408 to Access Point 5 via socket C2; Access Point 3 via socket C3 and Access Point AP2 via socket C4. The Access Points update their routing table. Access Point 5 forwards the Peer Update Request 408 to Peer P10 that updates its routing table and returns a peer update answer for 410 to Access Point 5. A peer update answer 412 is sent from Access Point 5 to Access Point 1. The peer update answer 410 from Peer P10 is sent to Access Point 1. A peer update answer 414 is sent from Access Point 1 to Peer P4 that updates its routing table. Access Point 1 forwards the peer update answer 412 from Access Point 5 to P4, which updates its routing table. The Access Point 1 forwards the peer update answer 410 from P10 to Peer P4 that update its routing table.

Summarizing when Peer P4 joins the network it sends a peer update request broadcast message to every Peer, this message updates all the Peers. All the Peers will have a new item in their routing table, which consists of the address of the new Peer and the connection where the message comes from. This connection can be changed when the connection comes with a better hop count from the new Peer. All the Peers receiving the Peer update request messages will reply with a Peer update answer message, which updates the routing table of Peer P4.

FIG. 4B describes a ladder diagram for sending a “Hello” message from Peer P4 to Peer P10. In an operation 420, Peer P4 creates a message 422 including a destination address for P10 (7865); a sending address (8865) for P4 and a text message “Hello”. In an operation 421, Peer P4 enters the routing table 402 (FIG. 4) and looks up the address of P10 and the socket C1 identified as the link to Access Point 1. The message 422 is sent to Access Point 1 which in an operation 424 looks up the address 7865 in the routing table and identifies socket C2 as the link to P10 via Access Point 5. The Access Point 1 routes the traffic via normal TCP mechanisms when the network has been setup. Access Point 5 receives the message 422 and performs a lookup operation 426 for address 7865 in the routing table (not shown) and identifies socket C6 as the link to P10 at address 7865. In an operation 428, Peer P10 receives the “Hello” message from Peer P4.

FIG. 4C describes the middleware in Peer P10 receiving a data message 440 from Peer P4. The Connection Element 306 listens, opens and processes the message for the Network Element 304. The Network Listener 316 displays the message to the user, after notification by the Network Element. The Peer P4 is notified by the Network Element that the message was received by placing a response in the Outgoing Message Queue for delivery to Peer P4 via Socket Connection C1.

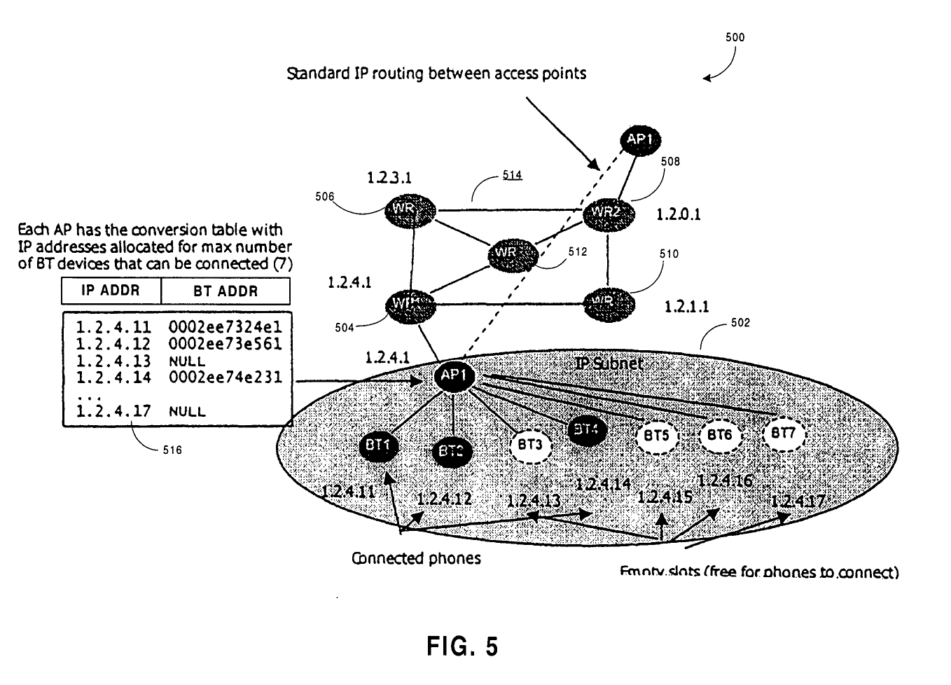

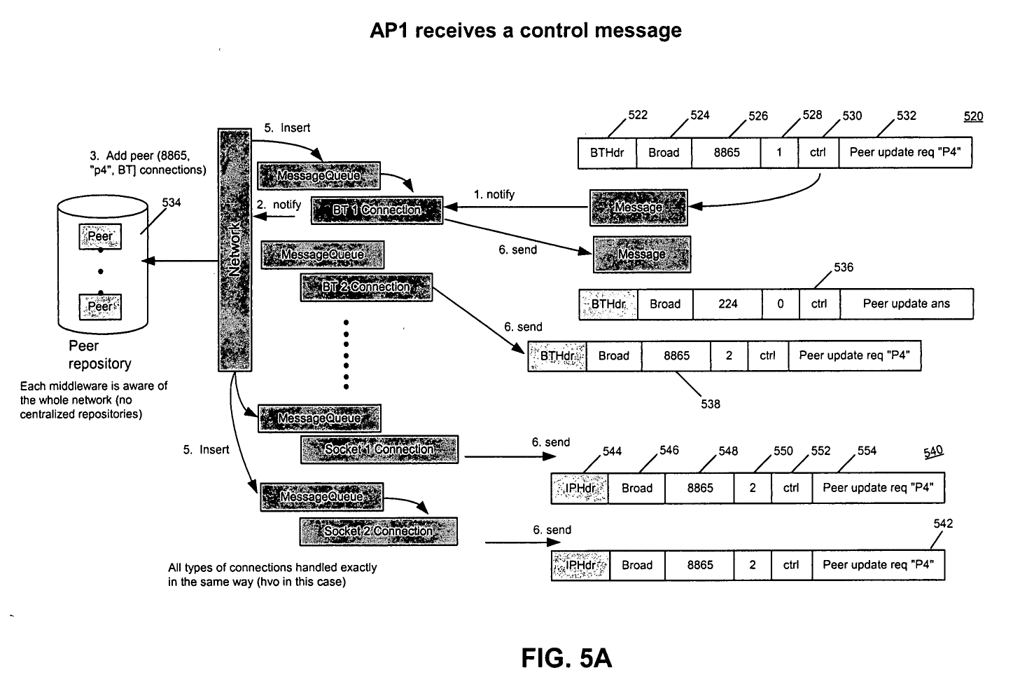

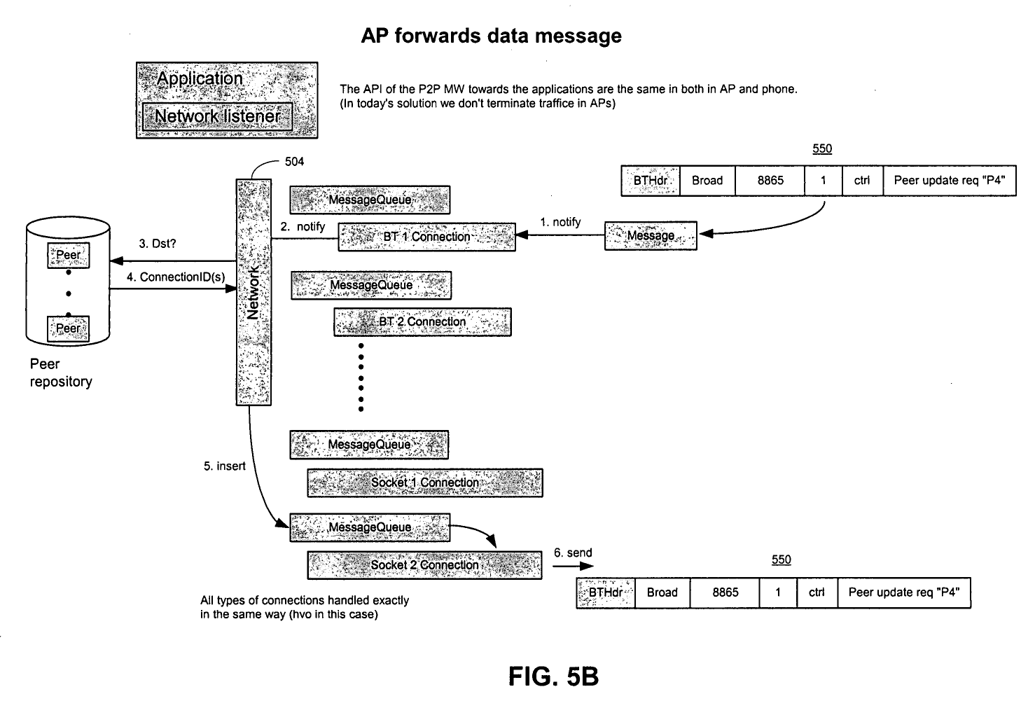

FIG. 5 discloses an addressing and routing diagram 500 for linking Access Points in the Mesh Infrastructure 100 (See 1) via wireless routers 504, 506, 508, 510, and 512, coupled together in a closed loop. 514 Access Point 1 is coupled to Bluetooth devices BT1 . . . . BT7. Every Access Point has an IP-BT conversion table 516 allocating/listing one IP address for each BT enabled device in its table. The available IP address space per Access Point equals the maximum number of BT devices that can be connected to the Access Point. Each peer is identified in the conversion table 516 with a unique Bluetooth Address (BT ADDR), e.g., 1.2.4.11; 1.2.4.12, etc., and an IP address, e.g., 0002ee7324el, 002ee73e561, etc. The Access Point can handle more than one Bluetooth (Bluetooth connection), as well as an IP connection to other Access Points via IP based wireless routers 504 . . . 512. In this way, every Access Point maintains its IP subnet to support the IP routing. Routing from an Access Point to another Access Point is done over the closed loop 514 corresponding to wireless LAN 112 in Mesh Infrastructure 110 (See FIG. 1). An addressing solution can fully utilize the existing IP routing in an underlying layer. If peer A sends a message to peer B then peer A has to find out the address of peer B. Two possible solutions:
a) peer A initiates a search (broadcast message to every access point) to get the address of peer B. The search message includes the search criteria (e.g. name, phone number).
b) every access point would replicate and store other access points' IP-BT conversion table. In this case peer A can find the address of peer B in its access point IP-BT conversion table.

FIG. 5A provides additional details regarding Access Point 1 receiving a control message from P4 (8865). Peer P4 creates a Bluetooth message 520 including a header field 522 a destination field 524; a sender field 526; a message type 528; a message title 530, and an update message 532 for Peer P4. The message 520 is sent to Access Point 1 via Socket C1 and is processed by the middleware software 300 (See FIG. 3) at the Access point. The Connection Element 302 notifies the Network element 304 of the update message and the Network Element adds the update message to a Peer repository 534. The Network Element via the Outgoing Message Queue 308 returns the update answer to API in a message 536 at the address 224 via Socket C1 and to Peer P4 at the address 8865 in an update message 538. The Network Element also prepares IP messages 540 and 542, each message including a IP header 544; a destination address 546; a sender address (8865) 548, a message class 550; a message type 552 and an update message 554 from Peer P4. The IP messages 540 and 542 are sent via sockets C1 and C2 to the peers served by the Access Points AP! and AP5.

FIG. 5B describes the middleware at an Access Point forwarding a data message 550 received from Peer P4 for delivery to Access Point 5 via Socket C2. The Connection Element 302 (FIG. 300) listens and opens the message for the Network Element 304, which interrogates the Peer Repository 534 for the connections to deliver the message. The Network Element places the message 550 in the Outgoing Message Queue 308 (FIG. 3) for delivery to AP 5 via Socket C2.

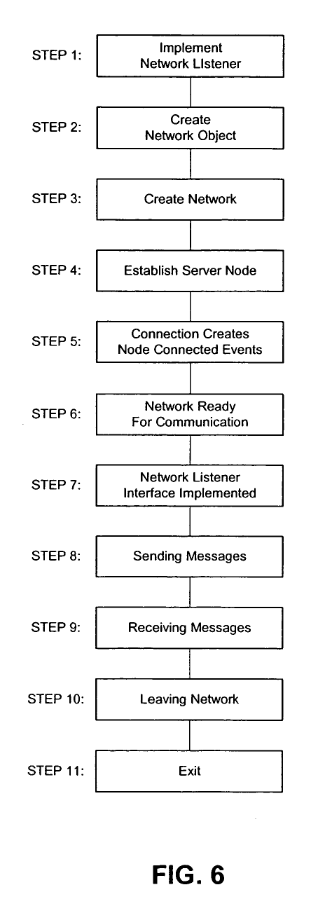

FIG. 6 is a flow diagram describing middleware operation in a peer device for forming a P2P network; sending a communication; receiving a communication, and leaving a network FIG. 6 in conjunction with FIG. 3 and Table 2, describes the operations, as follows:
Step 1: On every node one class implements the NetworkListener interface to monitor the network events:
Step 2: The Network object is created to execute network commands and provide access to some network data:
Step 3: using the Network. open method, the nodes are connected to create the network.
Step 4: The remaining one node (client node) should open the network for every server nodes.
Step 5: The connection created and node connected events are implemented:
Step 6: When the connections are created, the network is ready for the communications.
Step 7: The NetworkListener interface is implemented
Step 8: P2P middleware sends message, as follows:
   1. Select the connections from the routing table where the message should be forwarded.
   2. Add the message to the outgoing message queues of the selected connections.
   3. The message queues are working in FIFO (first-in, first-out) order.
   4. The message is sent after removal from the queue.
      Steps 1 and 2 are handled in the Network class.
Step 9: P2P middleware receives message, as follows:
   1. The connection thread is waiting for the incoming data.
   2. When the thread receives the data sent by another side, the thread creates a message from the data.
   3. Thread realizes that the message is for the associated peer.
   4. Thread puts the message into the incoming message queue. The message queue is working in FIFO (first-in, first-out) order.
   5. When the message is removed from the queue, the queue notifies the client application by calling the NetworkListener.
      Steps 1 and 2 and 3 are handled in the Connection class.
Step 10: P2P application and Middleware leave the network
   A. P2P application functions:
      1. Close all connections:
      2. When a connection is closed, the application is notified by the NetworkListener.connection
   B. P2P middleware leaves the network
      1. For all active connections, middleware sends ‘Connection Close’ message to notify the another end of the connections.
      2. Terminate the connection.
      3. Remove the connection and update the routing table.
      4. Notify the application by calling the NetworkListener.
         Steps 1 and 2 and 3 are handled in the Network class
Step 11 Exiting from network is done by executing a disconnect command.

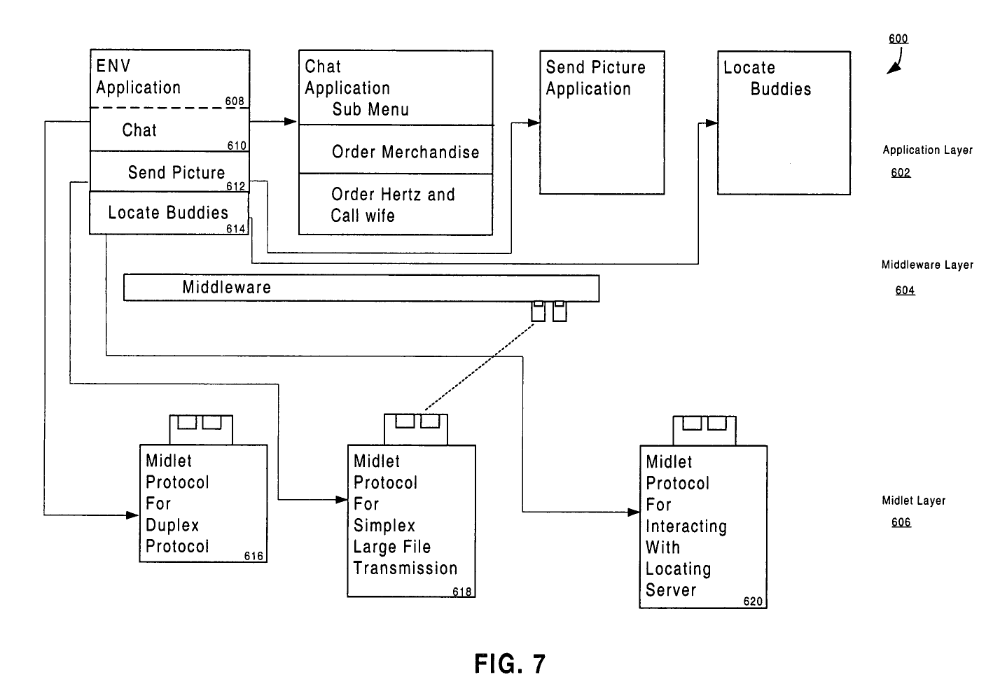

FIG. 7 describes Bluetooth protocol stack layers 600 installed in a mobile device for implementing peer to peer proximity applications using an application layer 602, and a middleware layer 604 including Midlet Applications.606. In operation, the user in block 608 displays a menu of applications, for example, Chatting 610; Send Picture 612 and Locate Buddies 614. The user selects the application of choice and activates the middleware to implements the application, as described below. Any number of proximity applications can be stored in the device, according to available memory capacity. The selected applications to be described are only exemplary of the applications that can be stored in the device, and are not to be deemed as limiting the invention.

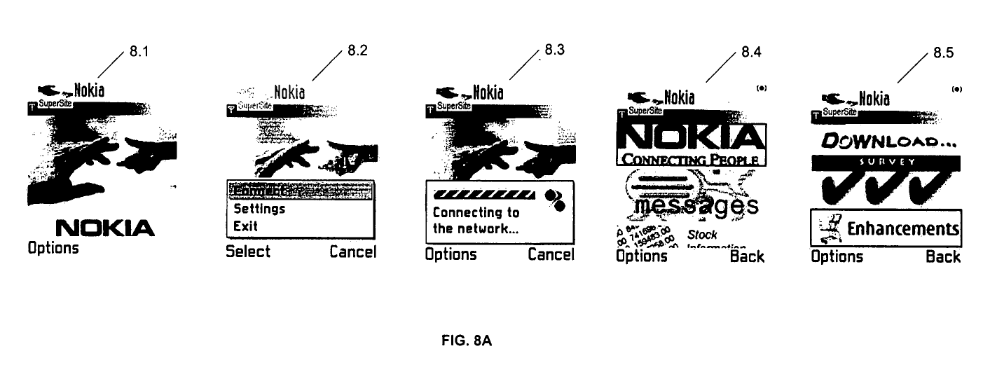

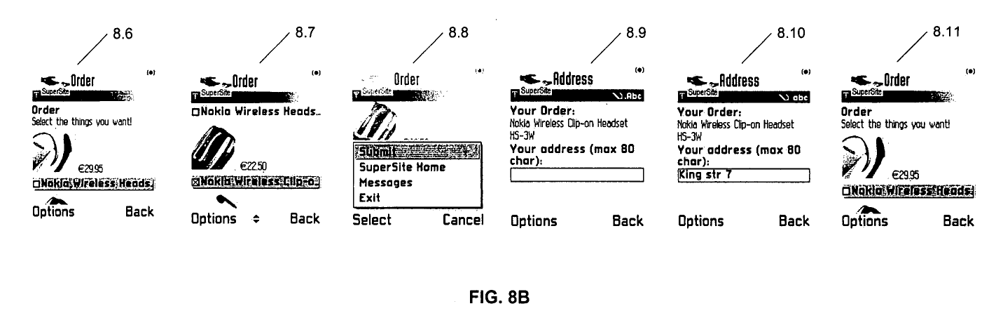

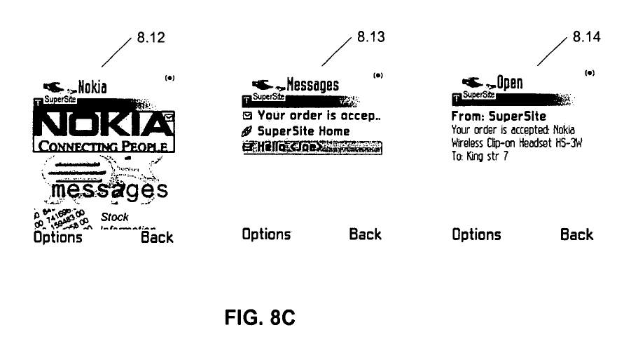

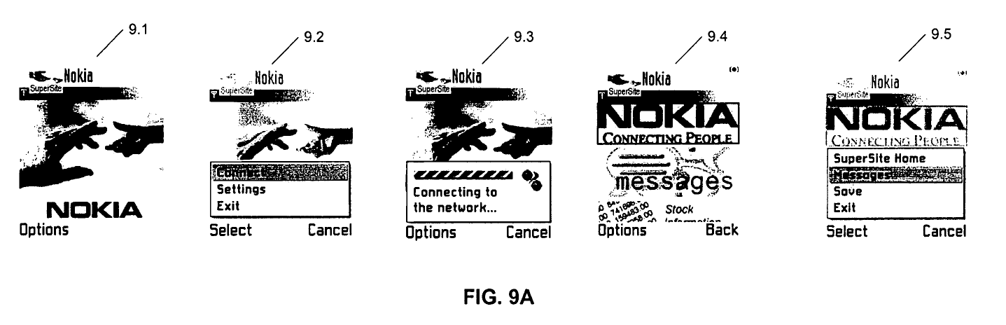

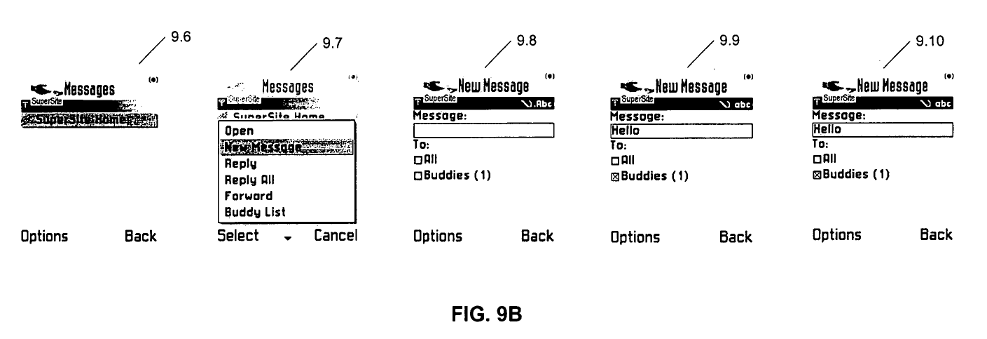

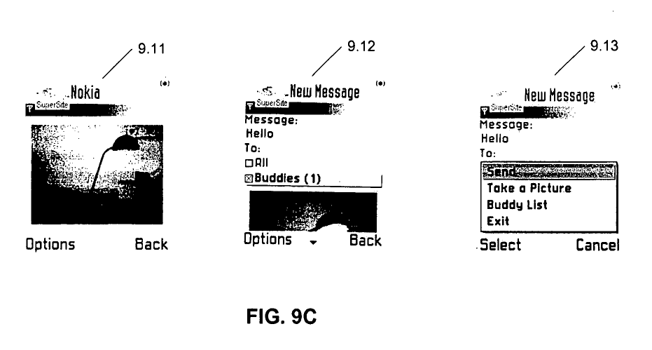

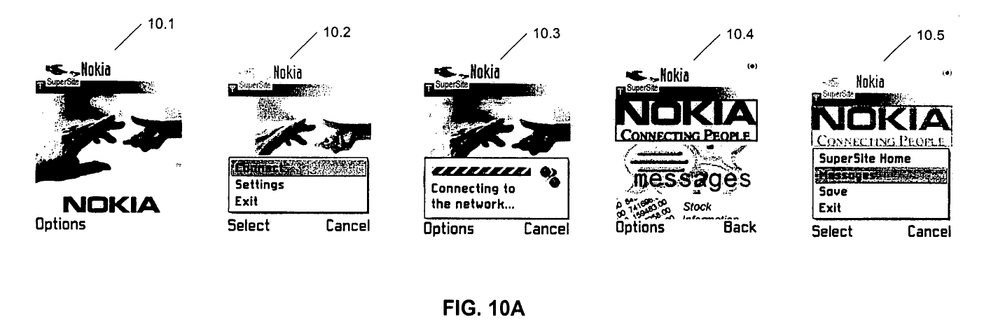

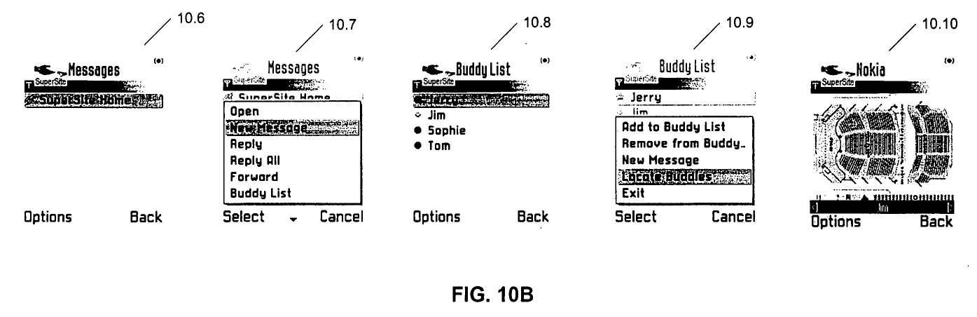

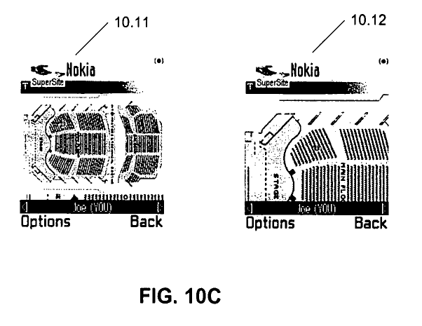

When a user selects the Chatting application 610 and Order Merchandise, a Midlet Application 616 is activated and plugged into the middleware 604. The Midlet Application 616 customizes the middleware for duplex transmission in conducting the selection and purchase of merchandise by the user from a sales department or the like, as will be describe in conjunction with FIG. 8A-8C. When the Send Picture application 612 is selected by the user, a Midlet Application 618 is activated and plugged into the middleware 604 to customize the middleware for simplex transmission of a picture to a receiving device, as will be described in conjunction with FIGS. 9A-9C. When the Locate Buddy application 614 is selected by the user, a Midlet Application is activated to customize the middleware to interact with a server for locating a Buddy at an athletic event, as will be described in conjunction with FIGS. 10A-10C.

FIGS. 8A-8C describe screen sequences in a mobile device for a user ordering merchandise from a Nokia SuperSite. In FIG. 8A, Screen 8.1 is a welcoming screen for accessing the SuperSite. Screen 8.2 provides the user with a connect screen in which the user has highlighted “connect”. Screen 8.3, indicates the user is being connected to the network serving the Supersite. Screen 8.4 is a message screen from the Supersite for receiving messages. In Screen 8.5, the SuperSite downloads product lists and a shopping cart. In FIG. 8B, the Supersite in Screen 8.6 provides the user an order form and displays an image of a Nokia Wireless Head including the price in Euros, after the user highlights “Nokia Wireless Heads”. In Screen 8.7, the user has highlighted “Nokia Wireless Clip-On” which is displayed including the cost at 22.5 Euros. The user selects the Nokia Wireless Clip-On” in Screen 8.7, and proceeds to submit an order for the clip-on headset in Screen 8.8. In Screen 8.9, the SuperSite displays the user's order, including a model number and requests a user address, not exceeding 80 characters. In Screen 8.10, the user provides an address for the order in the Screen 8.8. Screen 8.11 displays the order screen for the Nokia Wireless Head, which the user does not select. In FIG. 8C, the SuperSite provides a message screen in Screen 8.12, and in screen 8.13, the Supersite sends a message to the user (Joe) indicating his order has been accepted. The Order process ends in Screen 8.14, which describes the order, accepted by the SuperSite and the user's address for shipping the product.

FIGS. 9A-9C describe a screen sequence in the device for a user taking a picture and sending the picture in a simplex transmission to selected users served by the SuperSite. In FIG. 9A, Screens 9.1-9.4 duplicate Screens 8.1-8.4 in FIG. 8A and need no further explanation. Screen 9.5 is a messaging screen enabling the user to connect to people by highlighting the message option. In FIG. 9B, the user connects to the SuperSite in Screen 9.6 by highlighting SuperSite home screen. In Screen 9.7, the Supersite displays messaging options and the user selects the new message option. Screen 9.8 provides space for the user to enter a message and select addressees. The user in Screens 9.9 and 9.10 inscribes a “Hello” message in the message space and selects buddies as addressees. In FIG. 9C, a picture is taken of the user's work space in Screen 9.11. The picture is taken using a picture taking function included in the mobile device. The picture is attached to a message to buddies in Screen 9.12. The process ends in Screen 9.13 when the message and picture are sent to the buddies by highlighting the “Send” option.

FIGS. 10A-10C describe a user at a sporting event locating friends or buddies attending the event. In FIG. 10A, Screens 10.1-10.5 correspond to Screens 9.1-9.5 in FIG. 9A and need no further explanation. In FIG. 10B, the user highlights and selects the SuperSite Home screen in Screen 10.6 and in Screen 10.7 accesses a message screen including a Buddy List. After highlighting Buddy List, a list of Buddies is displayed in Screen 10.8. The user highlights Jerry and Jim in the Buddy List and Screen 10.9 provides the user a locate Buddies option which is highlighted for Jerry and Jim. The server in the arena in contact with users attending the sporting event activates the Service Discovery Protocol to locate Jim in Screen 10.8 and Joe (User) in Screen 10.11. After the Buddy connects to the server, a position locating system, described for example in U.S. Pat. No. 6,456,237, assigned to the same assignee as that of the present invention and fully incorporated herein locates the positions of the Buddies in the arena. For example, the position of Jim is located in the arena and transferred to a template of the arena, and shown by a darkened “+” mark in Screen 10.10. The location of Jerry's position in the arena can also be displayed in the screen. In FIG. 10C, the position of Joe (User) is displayed on the arena template, and shown by a darkened “+” in Screen 10.11. Screen 10.12 provides Joe a zoom-in view option to check seat location in the arena, if desired. The Locate Buddy Process ends after all selected Buddies and the User have been stored in the mobile device for recall, if desired.

Summarizing, the middleware stored in the user devices and access points enables applications to be seamlessly implemented in the network without any special protocols or connections.

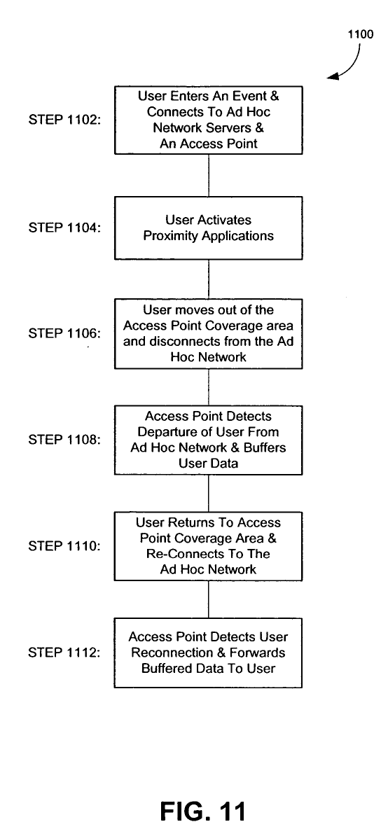

FIG. 11 describes a process 1100 for a proximity network involving an Access Point, which provides improved services to network users. The Access Point is adapted to buffer a user's data while the user is temporarily disconnected from the Access Point and provide the data when the user reconnects to the Access Point, as follows:
Step 1102: A user enters an event and after seating connects to an adhoc network via an access point within the user's range of connectivity.
Step 1104: The user executes various network services including chatting, games, video/audio downloading, etc.
Step 1106: The user temporarily moves out of the range of the Access Point coverage in roaming about the event for other services. Step 1008: The Access point detects user's absence by the failure of the user to regularly transmit in reserved slots whether or not they are replying to the server and proceeds to buffers data to its database intended for the user.
Step 1110: The user returns to the seat at the event and re-connects to the network
Step 1112: The Access Point detects user re-connection to the network and forwards the buffered data to the user.

While the invention has been described in terms of a preferred embodiment, various changes can be made therein without departing from the spirit and scope of the invention, as defined in the appended claims, in which:

1. In a short-range wireless system, a wireless extended proximity network, comprising:
a) a plurality of access points, each access point coupled to a proximity network including at least one mobile device for peer to peer communication;
b) means coupling the access points in a network; and
c) means installed in each mobile device and access point enabling each peer to communicate with any peer in the mesh network.

2. The proximity network of claim 1 further comprising:
d) router means connecting each access point to the mesh network.

3. The proximity network of claim 1 further comprising:
e) short-range communication links connecting each access point to mobile devices in an associated proximity network.

4. The proximity network of claim 1 further comprising:
f) means included in each access point enabling communication with other access point using Transaction Control Protocol/Internet Protocol (TCP/IP) and/or UDP/IP.

5. The proximity network of claim 1 wherein the means enabling each peer to communicate with any peer in the mesh network comprises middleware installed in a short-range communication protocol stack beneath an application layer in the stack.

6. The proximity network of claim 5 wherein the middleware comprises a connection class and a network class, the connection class representing and managing IP sockets or short range based connection channels and the network class responsible for routing messages, managing connections and maintaining a list of available peers.

7. The proximity network of claim 6 further comprises a network listener interacting with the network class to inform the application layer about different network events.

8. The proximity network of claim 6 further comprises at least one mobile information device protocols (MIDP) and at least one application program interface (API) interacting with the connection class.

9. The proximity network of claim 6 further comprises a message class implementing input messaging for the connection class.

10. The proximity network of claim 6 further comprises an outgoing message queue class implementing outgoing messaging and storage for the connection class.

11. The proximity network of claim 6 further comprises an incoming message class implementing message receiving for the network class.

12. The proximity network of claim 1 further comprising
g) means installed in each access point and mobile device listing all peers in the network.

13. The proximity network of claim 1 further comprising
h) means installed in each access point converting mobile device addresses to mesh network addresses.

14. The proximity network of claim 1 wherein the mesh network is a wired or wireless local area network.

15. The proximity network of claim 1 wherein the means coupling the access point to the mesh network is a wireless router.

16. A method enabling a peer in a communication network to communicate with any peer in a mesh network, comprising:
a) forming a plurality of proximity networks, each proximity network including at least one mobile device coupled to an access point;
b) coupling the access points in a mesh network; and
c) installing middleware in the access points and the mobile devices enabling mobile devices to communicate with any mobile device in the mesh network on a peer to peer basis.

17. The method of claim 16 further comprising:
d) installing short-range communication links between the access points and the mobile devices.

18. The method of claim 16 comprising:
e) installing in each access point and mobile device a routing table listing all peer addresses and connections in the mesh network.

19. The method of claim 167 comprising;
f) installing in each access point a conversion table for converting mobile device addresses to mesh addresses of access point.

20. The method of claim 16 further comprising:
g) installing the middleware in a short range communication protocol stack beneath an application layer in the stack.

21. The method of claim 16 wherein the middleware in sending a message further comprises: (a) entering a routing table and selecting connections for forwarding the message; (b) adding the message to an outgoing queue of the selected connections and (c) sending the message from the outgoing queue on a first in-first out basis.

22. The method of claim 16 wherein the middleware in receiving a message from a client application further comprises (a) maintaining a connection thread for receiving incoming data; (b) creating a message from the incoming data; (c) identifying the recipient of the message; (d) storing the message in an incoming message queue; and (e) notifying the client application when the message is removed from the incoming message queue.

23. The method of claim 16 wherein the middleware in joining a peer-to-peer network further comprises: (a) creating a connection object based a URL type; (b) initiating a connection using the URL; (c) notifying an application attempting to join the peer-to-peer network; (d) sending a “Peer Update Request Message” to the network, and (e) updating routing tables in the network by processing “Peer Update Answer” message.

24. The method of claim 16 wherein the middleware leaves a peer-to-peer network further comprises: (a) sending a “Close Connection” message to active connections to notify the end of the connection; (b) terminating the connection; (c) removing the connection and updating a routing table; and (d) notifying a related application of the network departure.

25. A method of communicating on a peer to peer in a mesh network of adhoc short range communication networks, comprising:
a) maintaining a list of existing peers in a mesh network;
b) receiving a message from a sending peer in an adhoc network, the received message containing a recipient address of a receiver peer;
c) analyzing the received message;
d) based on the recipient address in the received message, determining a next level address for forwarding the received message without changing the recipient address in the received message;
e) replacing the next level of address without changing the recipient address in order to forward the message to the receiver peer; and
f) coupling the sending and receiver peers for communication with each other.

26. The method of claim 25 wherein the next level address of the received message is an address, which is in a different protocol address than in, the received message.

27. The method of claim 25 wherein the received message address is a Bluetooth address and the next level address is an IP address.

28. The method of claim 25 wherein receiving the message identified by the next level address is sent to the next level address and the next level address is converted to the Bluetooth address of the recipient address under the coverage of the next access point.

29. A medium, executable in a computer system, for enabling a peer in a communication network to communicate with any peer in a mesh network, the medium comprising:
a) program code for forming a plurality of proximity networks, each proximity network including at least one mobile device coupled to an access point;
b) program code for coupling the access points in a mesh network
c) program code installing middleware in a communication protocol stack enabling mobile devices to communicate with any mobile device in the mesh network on a peer to peer basis.

30. The medium of claim 29 further wherein the middleware in sending a message, comprises:
(a) program code entering a routing table and selecting connections for forwarding the message;
(b) program code adding the message to an outgoing queue of the selected connections; and
(c) program code sending the message from the outgoing queue on a first in-first out basis.

31. The medium of claim 29 wherein the middleware in receiving a message from a client application, comprises:
(a) program code maintaining a connection thread for receiving incoming data;
(b) program code creating a message from the incoming data;
(c) program code identifying a recipient of the message;
(d) program code storing the message in an incoming message queue; and
(e) program code notifying the client application when the message is removed from the incoming message queue.

32. The medium of claim 29 wherein the middleware in joining a peer-to-peer network, comprises:
(a) program code creating a connection object based on a URL type;
(b) program code initiating a connection using the URL;
(c) program code notifying an application attempting to join the peer-to-peer network;
(d) program code sending a “Peer Update Request Message” to the network, and
(e) program updating routing tables in the network by processing “Peer Update Answer” message.

33. The medium of claim 29 wherein the middleware leaves a peer-to-peer network, comprises:
(a) program code sending a “Close Connection” message to active connections to notify the end of the connection;
(b) program code terminating the connection;
(c) program code removing the connection and updating a routing table; and
(d) program code notifying a related application of the network departure.

34. A method enabling a user to continue to receive data while temporarily disconnected from a proximity network comprising:
(a) connecting a user attending an event to a proximity network via an access point having a coverage area;
(b) activating an application in the mobile device for acquisition of services from the proximity network;
(c) executing the application while connected to the proximity network;
(d) temporarily moving out of the coverage area of the access point;
(e) detecting the departure of the user from the proximity network by the access point;
(f) storing application data of the user in the access point while the user is out of the coverage area of the access point; and
(g) providing the stored application data to the user upon reconnection to the access point.

35. Apparatus enabling a user to continue to receive data while temporarily disconnected from a proximity network comprising:
(a) means connecting a user attending an event to a proximity network via an access point having a coverage area;
(b) means activating an application in a mobile device for acquisition of services from the proximity network;
(c) means executing the application while the mobile device is connected to the proximity network;
(d) means detecting the departure of the user from the proximity network by the access point;
(f) means storing application data in the access point while the user is out of the coverage area of the access point; and
(g) means providing the stored application data to the user upon reconnection to the access point.
